(19) United States
(12) Patent Application Publication
(10) Pub. No.: US 2020/0272979 A1
(43) Pub. Date: Aug. 27, 2020

(54) INVENTORY MANAGEMENT BASED ON REAL-TIME NOTIFICATIONS TO A DISTRIBUTION MECHANISM

(71) Applicant: Carrier Corporation, Palm Beach Gardens, FL (US)

(72) Inventors: Robert A. Chopko, Baldwinsville, NY (US); Thibaut Gavignet, Liverpool, NY (US); David C. Brondum, Cazenovia, NY (US); Jeremy Dobrowolski, Rockford, IL (US); Andreas Wallmeyer, Recke (DE); Lewis Gordon Curtis, Georgetown, NY (US)

(21) Appl. No.: 16/063,677

(22) PCT Filed: Dec. 13, 2016
(86) PCT No.: PCT/US16/66306

§ 371 Date: Jun. 18, 2018

(30) Foreign Application Priority Data
Dec. 18, 2015 (US) 62269225

(51) Int. Cl. G06Q 10/08; G06Q 50/12; G06Q 50/28

(52) U.S. Cl. CPC G06Q 10/087; G06Q 10/0833; G06Q 50/28; G06Q 50/12; G06Q 10/0838

(57) ABSTRACT

The present disclosure relates to order fulfillment. Order fulfillment includes receiving a signal indicating an inventory status and tracking, by the processor, delivery information based on the inventory status of the signal. Further, order fulfillment includes determining whether the delivery information trigger a delivery based on inventory thresholds and communicating a delivery notification to fulfill a depleted inventory in response to the determining that the delivery information triggers the delivery.

### BACKGROUND

In general, a footprint of a commercial kitchen in a restaurant contains a walk-in freezer-cooler to store products for extended periods of time. The walk-in freezer-cooler are intended for employee access, but are often compromised for delivery access. Consequently, the products may stay in the walk-in freezer-cooler longer than necessary, affecting quality and inventory management of the products. Also, a location of the walk-in freezer-cooler in the kitchen and cooler usually provides inefficiency with respect to labor time associated with taking the products from the walk-in freezer-cooler to where the products are processed in the kitchen.

### BRIEF DESCRIPTION

According to an embodiment, a method for order fulfillment is provided. The method includes receiving, by a processor coupled to a memory, a signal indicating an inventory status; tracking, by the processor, delivery information based on the inventory status of the signal; determining, by the processor, whether the delivery information triggers a delivery based on inventory thresholds; and communicating, by the processor, a delivery notification to fulfill a depleted inventory in response to the determining that the delivery information triggers the delivery.

According to another embodiment or the method embodiment above, the signal can be received from a quick serve restaurant.

According to another embodiment or any of the method embodiments above, the signal can be received from a freezer-less space of the quick serve restaurant and the freezer-less space can include electrical circuitry that tracks which products have been placed in the freezer-less space and changes to the products within the freezer-less space.

According to another embodiment or any of the method embodiments above, the delivery information can include a time consumed to deliver to the freezer-less space and the freezer-less space can include a door on an external wall of the quick serve restaurant.

According to another embodiment or any of the method embodiments above, the inventory status can include an amount of product located at a quick serve restaurant, a food production over time, a weight of a package, or location of a product.

According to another embodiment or any of the method embodiments above, the delivery information can include time of day, time to delivery, current traffic patterns, inventory need, product priority, or product type.

According to an embodiment, a system for order fulfillment is provided. The system comprises a processor and a memory storing program instructions for order fulfillment thereon. The program instructions executable by the processor to cause the system to perform receiving a signal indicating an inventory status; tracking delivery information based on the inventory status of the signal; determining whether the delivery information triggers a delivery based on inventory thresholds; and communicating a delivery notification to fulfill a depleted inventory in response to the determining that the delivery information triggers the delivery.

According to another embodiment or the system embodiment above, the signal can be received from a quick serve restaurant.

According to another embodiment or any of the system embodiments above, the signal can be received from a freezer-less space of the quick serve restaurant and the freezer-less space can include electrical circuitry that tracks which products have been placed in the freezer-less space and changes to the products within the freezer-less space.

According to another embodiment or any of the system embodiments above, the delivery information can include a time consumed to deliver to the freezer-less space and the freezer-less space can include a door on an external wall of the quick serve restaurant.

According to another embodiment or any of the system embodiments above, the inventory status can include an amount of product located at a quick serve restaurant, a food production over time, a weight of a package, or location of a product.

According to another embodiment or any of the system embodiments above, the delivery information can include time of day, time to delivery, current traffic patterns, inventory need, product priority, or product type.

Additional features and advantages are realized through the techniques of the present disclosure. Other embodiments and aspects of the disclosure are described in detail herein. For a better understanding of the disclosure with the advantages and the features, refer to the description and to the drawings.

### BRIEF DESCRIPTION OF THE DRAWINGS

The subject matter which is regarded as the present disclosure is particularly pointed out and distinctly claimed in the claims at the conclusion of the specification. The foregoing and other features, and advantages of the present disclosure are apparent from the following detailed description taken in conjunction with the accompanying drawings in which:

FIG. 1 depicts a system for distributing product to a freezer-less space according to an embodiment;

FIG. 2 depicts a process flow representing an example of an order fulfillment process according to an embodiment; and

FIG. 3 depicts a processing system according to an embodiment.

### DETAILED DESCRIPTION

Embodiments herein relate to a system of a restaurant that utilizes a freezer-less space in a kitchen area. The freezer-less space can replace or mimic a contemporary walk-in cooler and is capable of holding products for short-term storage. The freezer-less space can be centrally located to enable employees of a restaurant to access the products from a single location while reducing a walking time and reducing product idle time between the freezer-less space and a processing area. The freezer-less space can also be located with respect to an external wall of the restaurant to enable re-stocking deliveries from outside the restaurant without disturbing the employees inside the restaurant. The freezer-less space, products, and system of the restaurant can also utilize tracking technology from the products entering into the freezer-less space, leaving the freezer-less space, and traveling to the processing area. In turn, the system of the restaurant can communicate with a distribution mechanism to schedule further deliveries of the products.

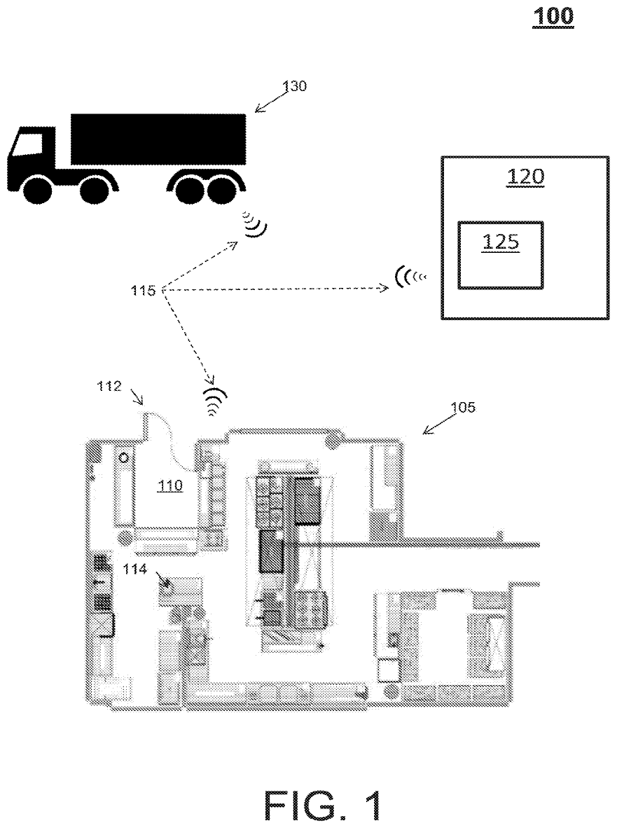

Turning now to FIG. 1, a system 100 is generally shown in accordance with an embodiment. The system 100 includes a quick serve restaurant 105 with a freezer-less space 110, a door 112, and a processing area 114. Further depicted is communication 115 between the quick serve restaurant 105, a distribution center 120 (e.g., the computer sub-system 125), and a delivery service 130.

The quick serve restaurant 105 is representative of any restaurant or facility for serving fast, efficient, take-out-ready products, such as food products that experience a high-turn over time. While the term “quick-serve” can include and/or be synonymous with “fast food,” quick-serve is a broader term that extends beyond fast food to include kiosks, food stands, food trucks, drive-through restaurants, coffee shops, cafes, drive-ins, dinners, convenience stores, deli shops, and like. The door 112 is a door to the freezer-less space and is located with respect to an external wall of the quick serve restaurant 105 to enable re-stocking deliveries from outside the quick serve restaurant 105 without disturbing the employees inside the restaurant or creating delivery traffic around the processing area 114.

The freezer-less space 110 of the system 100 facilitates product to be stored in a ready-to-use state for a short term in a cooler. In turn, the quick serve restaurant 105 can move away from frozen products stored in a contemporary walk-in freezer-cooler, and instead choose fresh products stored in the freezer-less space 110. The freezer-less space 110 includes electrical circuitry that provides the ability to track what products have been placed in the freezer-less space 110, track changes to the products within the freezer-less space 110, track what products have been removed in the freezer-less space 110, and track inventory of the products with respect to inventory thresholds. The electrical circuitry of the freezer-less space 110 can include any scanner, transceiver, optical detector capable of counting product inventory and broadcasting a notification to elements of the system 100.

Inventory thresholds are metrics designed to trigger notifications at a point when a particular amount of a product is sufficiently low that the product needs to be restocked. Without restocking, the product will be depleted, and the quick serve restaurant 105 will not be able to serve that depleted product. Examples of Inventory thresholds include but are not limited to fixed values, fixed integers, ranges, and rate of change. Inventory thresholds can be associated and/or managed with respect to time metrics, such as a first inventory threshold can be a fixed integer during off-peak hours for the quick serve restaurant 105 and change to a rate of depletion during peak-hours.

Notifications, in general, are identifying information (or non-existence of the information) targeted to systems or users responsible for the deliveries. Examples of notifications may include, but are not limited to, any combination of audio alerts (e.g., buzzers, bells, tones, telephone calls, cellphone calls, VoIP calls, voicemails, loudspeaker announcements, etc.), visual displays (e.g., flashing lights, display pop-ups), pager (e.g., SNPP), electronic mail (e.g., POP, IMAP, SMTP), desktop alerts (e.g., dialog, balloon, modal window, toast, etc.), instant messaging (e.g., IRC, ICQ, AIM, Yahoo! Messenger, MSN, XMPP, iMessage), text messaging (e.g., SMS), and the like.

In an embodiment, the quick serve restaurant 105 can include appliances and other devices that can work independent of or in conjunction with the freezer-less space 110 to track products. For instance, an appliance, such as a fryer, can include electrical circuitry that provides the ability to track an amount of products cooked. The amount of products cooked can relate to cycles of operation over time, weight of food cooked, etc. In turn, this information can be utilized to verify a rate of change of product inventory to support anticipatory deliveries as described below.

The communication 115 between the elements of the system is representative of any communication scheme that facilities automatic and/or instant electronic interaction between the quick serve restaurant 105, the freezer-less space 110, the distribution center 120, the computer sub-system 125, and/or a delivery service 130. A communication scheme can be any network, as further described below, capable of supporting multiple wire and wireless technologies and protocols.

The distribution center 120 can be any facility or other specialized building (with refrigeration) that stocks products for distribution to the quick serve restaurant 105. The distribution center 120 includes the computer sub-system 125 to perform an order fulfillment process, as further described below. Distribution centers are usually thought of as being demand driven. Examples of the distribution center 120 include but are not limited to a fulfillment center, warehouse, a cross-dock facility, a bulk break center, and a package handling center.

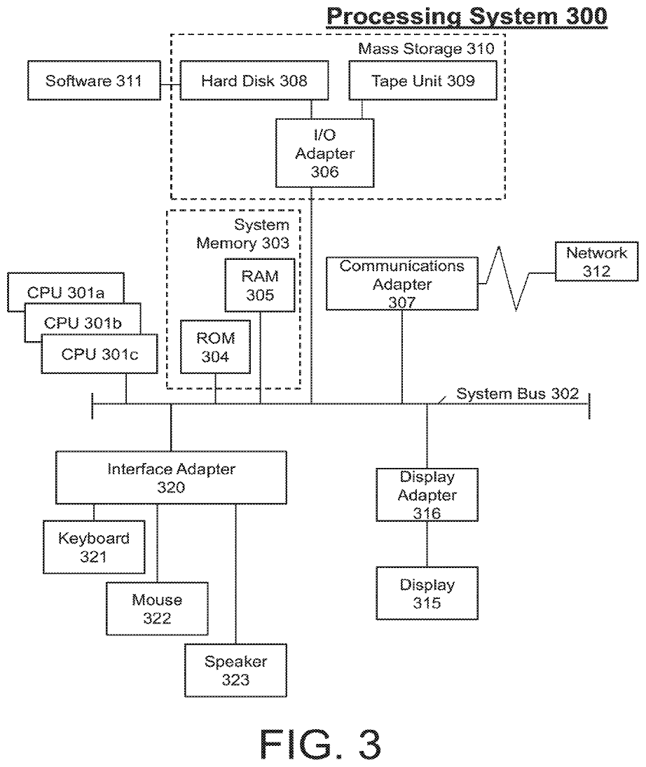

The computer sub-system 125 can be any computing device, such as the processing system 300 of FIG. 3 described below. Note that the computer sub-system 125 can include or receive a computer readable storage medium (or media) having computer readable program instructions thereon for causing a processor of the computer sub-system 124 to carry out aspects of the order fulfillment process.

The delivery service 125 can be any transportation mechanism for moving product from the distribution center 120 to the quick serve restaurant 105. Examples of a delivery service include a delivery truck, a freezer truck, a train car service, a bicycle deliver service, and a driver-less vehicle service. In an embodiment, the delivery service 125 can include the computer sub-system 125 and the operations of the distribution center 120, such that the delivery service is a single mobile point for performing the order fulfillment process. Thus, the distribution center 120 and/or the delivery service 125 can be considered a distribution mechanism.

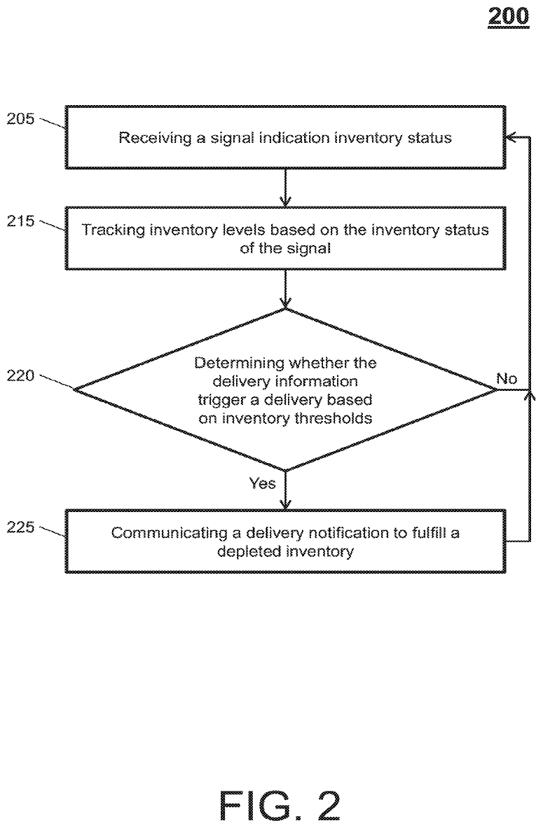

Turning now to FIG. 2, a process flow 200 representing an example of an order fulfillment process is generally shown in accordance with an embodiment. At block 205, a signal is received indicating inventory status. The signal can be communicated 115 from the quick serve restaurant 105 to the computer sub-system 125 of the distribution center 120. The signal can be initiated automatically based on product tracking performed by the freezer-less space 110 and/or appliances of the quick serve restaurant 105. That is the signal can reflect food production over time, weight of a package, location of a package, amount of packages, etc.

In an embodiment, radio frequency identifications (RFIDs) can be utilized by the freezer-less space 110 to track products in transit (e.g., from the delivery service 120 to the freezer-less space 110 of the quick serve restaurant 105, within portions of the freezer-less space 110, and from the freezer-less space 110 to a processing area). For example, RFID chips can be implanted on product packaging such that a product can be tracked as it transitions. Product packaging can include but is not limited to freezer boxes, freezer bags, shrink wrap, cardboard crates, and Styrofoam crates. In another embodiment, code scanners can be utilized to track products. For example, barcodes or the like can be placed on an exterior of the product packaging such that a product can be tracked as it transitions.

At block 215, delivery information is tracked based on the inventory status indicated by the signal. In this regard, the computer sub-system 125 can be configured to monitor and store the delivery information along with other system information. The system information includes, but is not limited to time of day, a time to delivery, current traffic patterns, inventory need, product priority, product type, restaurant priority, etc. This system information can also include product movement from the distribution center 120 to the delivery service 130, from the delivery service 120 to one of the quick serve restaurant 105, from the delivery service 120 to the freezer-less space 110 of one of the quick serve restaurant 105, within portions of any freezer-less space 110, from the freezer-less space 110 to a processing area, etc. This system information can also include a weight of the delivery service (e.g., weight of the truck), weight of packages in the truck, and a configuration of a destination.

In turn, at block 220, a determination is made as to whether the delivery information should trigger a delivery based on inventory thresholds. The computer sub-system 125 performs this determination. In an embodiment, the determination includes making a comparison between the inventory thresholds and the tracked inventory status.

In this regard, the computer sub-system 125 can be configured to anticipate and/or initiate a delivery to the quick server restaurant 105 based on the inventory status. The computer sub-system 125 can be configured to utilize a time of day, a time to delivery, current traffic patterns, inventory need, product priority, product type, restaurant priority, etc. to anticipate and/or initiate the delivery.

In an embodiment, the computer sub-system 125 is configured to anticipate and/or initiate multiple deliveries to multiple quick server restaurants 105. For example, multiple quick server restaurants 105 in a geographic area can be aligned with a single distribution center 120, which manages a continuous round of delivery services 125 (e.g., trucks) making deliveries. The computer sub-system 125 can be configured to utilize product tracking information received from the trucks to anticipate and/or initiate deliveries.

In an embodiment, the computer sub-system 125 is configured to manage the deliveries based on the configuration of the destination. For example, the computer sub-system 125 can determine whether the delivery information are related to the freezer-less space 110 or related to a contemporary walk-in freezer-cooler used by the quick serve restaurant 105. The computer sub-system 125 can determine a time consumed to deliver to a freezer-less space 110 and a time consumed to deliver to the contemporary walk-in freezer-cooler. As the freezer-less space 110 with the door 112 external to the quick serve restaurant 105 will consume less time than delivering to the contemporary walk-in freezer-cooler, the computer sub-system 125 can utilize this time variation to prioritize the quick serve restaurants 105 with the freezer-less spaces 110 for deliveries (thereby maximizing the number of deliveries in the shortest amount of time).

In an embodiment, the electrical circuitry of the freezer-less space 110 can be configured to anticipate and/or initiate a delivery as described above.

If the computer sub-system 125 determines that a delivery is not required based on the tracked delivery information, then the process flow 200 can loop hack to receiving a signal at block 205. If the computer sub-system 125 determines that a delivery is required based on the tracked delivery information, then the process flow 200 proceeds to block 225.

At block 225, a delivery notification (e.g., a notification as described above) is communicated to the delivery service 125 to fulfill a depleted inventory. That is, once an inventory threshold is reached for any product, a notification can be communicated 115 to the computer sub-system 125 so that the order fulfillment process can proceed before that product is depleted. In an embodiment, the delivery service 130 can be constantly mobile (e.g., making rounds) to enable special and/or directed deliveries upon receiving the delivery notification that any inventory threshold has been met or exceeded. After the delivery notification is communicated, the process flow 200 can loop back to receiving a signal at block 205.

Referring now to FIG. 3, there is shown an embodiment of a processing system 300 for implementing the teachings herein. In this embodiment, the processing system 300 has one or more central processing units (processors) 301a, 301b, 301c, etc. (collectively or generically referred to as processor(s) 301). The processors 301, also referred to as processing circuits, are coupled via a system bus 302 to system memory 303 and various other components. The system memory 303 can include read only memory (ROM) 304 and random access memory (RAM) 305. The ROM 304 is coupled to system bus 302 and may include a basic input/output system (BIOS), which controls certain basic functions of the processing system 300. RAM is read-write memory coupled to system bus 302 for use by processors 301.

FIG. 3 further depicts an input/output (I/O) adapter 306 and a network adapter 307 coupled to the system bus 302. I/O adapter 306 may be a small computer system interface (SCSI) adapter that communicates with a hard disk 308 and/or tape storage drive 309 or any other similar component. I/O adapter 306, hard disk 308, and tape storage drive 309 are collectively referred to herein as mass storage 310. Software 311 for execution on processing system 300 may be stored in mass storage 310. The mass storage 310 is an example of a tangible storage medium readable by the processors 301, where the software 311 is stored as instructions for execution by the processors 301 to perform a method, such as the process flows of FIG. 2. Network adapter 307 interconnects system bus 302 with an outside network 312 enabling processing system 300 to communicate with other such systems. A screen (e.g., a display monitor) 315 is connected to system bus 302 by display adapter 316, which may include a graphics controller to improve the performance of graphics intensive applications and a video controller. In one embodiment, adapters 306, 307, and 316 may be connected to one or more 110 buses that are connected to system bus 302 via an intermediate bus bridge (not shown). Suitable I/O buses for connecting peripheral devices such as hard disk controllers, network adapters, and graphics adapters typically include common protocols, such as the Peripheral Component Interconnect (PCI). Additional input/output devices are shown as connected to system bus 302 via an interface adapter 320 and the display adapter 316. A keyboard 321, mouse 322, and speaker 323 can be interconnected to system bus 302 via interface adapter 320, which may include, for example, a Super I/O chip integrating multiple device adapters into a single integrated circuit.

Thus, as configured in FIG. 3, processing system 305 includes processing capability in the form of processors 301, and, storage capability including system memory 303 and mass storage 310, input means such as keyboard 321 and mouse 322, and output capability including speaker 323 and display 315. In one embodiment, a portion of system memory 303 and mass storage 310 collectively store an operating system to coordinate the functions of the various components shown in FIG. 3.

Technical effects and benefits of embodiments herein include improving a layout of a kitchen, providing a minimal footprint via the freezer-less space, removing unwanted expenses of contemporary walk-in freezer-cooler, and improving an efficiency of restaurant operation and restocking the freezer-less space. Technical effects and benefits of embodiments herein also include improving inventory management through tracking of the products (e.g., tracking threshold levels of the products, automatic signals to local distribution warehouse, and anticipatory deliveries), providing directed temperature control of the products, and managing energy consumption within the restaurant.

Embodiments herein may be a system, a method, and/or a computer program product. The computer program product may include a computer readable storage medium (or media) having computer readable program instructions thereon for causing a processor to carry out aspects of the embodiments herein. The computer readable storage medium can be a tangible device that can retain and store instructions for use by an instruction execution device.

The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the embodiments herein may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, to perform aspects of the embodiments herein.

Aspects of the embodiments herein are described herein with reference to flowchart illustrations and/or block diagrams of methods, apparatus (systems), and computer program products according to embodiments. It will be understood that each block of the flowchart illustrations and/or block diagrams, and combinations of blocks in the flowchart illustrations and/or block diagrams, can be implemented by computer readable program instructions. In this way, the flowchart and block diagrams in the FIGS. illustrate the architecture, operability, and operation of possible implementations of systems, methods, and computer program products according to various embodiments. Further, each block in the flowchart or block diagrams may represent a module, segment, or portion of instructions, which comprises one or more executable instructions for implementing the specified logical operation(s). In some alternative implementations, the operations noted in the block may occur out of the order noted in the FIGS. For example, two blocks shown in succession may, in fact, he executed substantially concurrently, or the blocks may sometimes he executed in the reverse order, depending upon the operability involved. It will also be noted that each block of the block diagrams and/or flowchart illustration, and combinations of blocks in the block diagrams and/or flowchart illustration, can be implemented by special purpose hardware-based systems that perform the specified operations or acts or carry out combinations of special purpose hardware and computer instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the operations/acts specified in the flowchart and/or block diagram block or blocks. These computer readable program instructions may also be stored in a computer readable storage medium that can direct a computer, a programmable data processing apparatus, and/or other devices to operate in a particular manner, such that the computer readable storage medium having instructions stored therein comprises an article of manufacture including instructions which implement aspects of the operation/act specified in the flowchart and/or block diagram block or blocks.

The computer readable program instructions may also he loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the operations/acts specified in the flowchart and/or block diagram block or blocks.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one more other features, integers, steps, operations, element components, and/or groups thereof.

While the present disclosure has been described in detail in connection with only a limited number of embodiments, it should be readily understood that the present disclosure is not limited to such disclosed embodiments. Rather, the present disclosure can be modified to incorporate any number of variations, alterations, substitutions or equivalent arrangements not heretofore described, but which are commensurate with the spirit and scope of the present disclosure. Additionally, while various embodiments of the present disclosure have been described, it is to be understood that aspects of the present disclosure may include only some of the described embodiments. Accordingly, the present disclosure is not to be seen as limited by the foregoing description, but is only limited by the scope of the appended claims.

1. A method for order fulfillment, comprising:
receiving, by a processor coupled to a memory, a signal indicating an inventory status;
tracking, by the processor, delivery information based on the inventory status of the signal;
determining, by the processor, whether the delivery information triggers a delivery based on inventory thresholds; and
communicating, by the processor, a delivery notification to fulfill a depleted inventory in response to the determining that the delivery information triggers the delivery.

2. The method of claim 1, wherein the signal is received from a quick serve restaurant.

3. The method of claim 1, wherein the signal is received from a freezer-less space of the quick serve restaurant, wherein the freezer-less space includes electrical circuitry that tracks which products have been placed in the freezer-less space and changes to the products within the freezer-less space.

4. The method of claim 1, wherein the delivery information includes a time consumed to deliver to the freezer-less space, and wherein the freezer-less space includes a door on an external wall of the quick serve restaurant.

5. The method of claim 1, wherein the inventory status includes an amount of product located at a quick serve restaurant, a food production over time, a weight of a package, or location of a product.

6. The method of claim 1, wherein the delivery information includes time of day, time to delivery, current traffic patterns, inventory need, product priority, or product type.

7. A system comprising a processor and a memory storing program instructions for order fulfillment thereon, the program instructions executable by the processor to cause the system to perform:
receiving a signal indicating an inventory status;
tracking delivery information based on the inventory status of the signal;
determining whether the delivery information triggers a delivery based on inventory thresholds; and
communicating a delivery notification to fulfill a depleted inventory in response to the determining that the delivery information triggers the delivery.

8. The system of claim 7, wherein the signal is received from a quick serve restaurant.

9. The system of claim 7, wherein the signal is received from a freezer-less space of the quick serve restaurant, and wherein the freezer-less space includes electrical circuitry that tracks which products have been placed in the freezer-less space and changes to the products within the freezer-less space.

10. The system of claim 7, wherein the delivery information includes a time consumed to deliver to the freezer-less space, and wherein the freezer-less space includes a door on an external wall of the quick serve restaurant.

11. The system of claim 7, wherein the inventory status includes an amount of product located at a quick serve restaurant, a food production over time, a weight of a package, or location of a product.

12. The system of claim 7, wherein the delivery information includes time of day, time to delivery, current traffic patterns, inventory need, product priority, or product type.
